(19) United States
(12) Patent Application Publication
(10) Pub. No.: US 2026/0299548 A1
(43) Pub. Date: Oct. 1, 2026

(54) INFORMATION PROCESSING DEVICE, INFORMATION PROCESSING SYSTEM, AREA DIVISION METHOD, AND STORAGE MEDIUM

(71) Applicant: HONDA MOTOR CO., LTD., Tokyo (JP)

(72) Inventor: Sotaro FURUTA, Tokyo (JP)

(73) Assignee: HONDA MOTOR CO., LTD., Tokyo (JP)

(21) Appl. No.: 19/544,526

(22) Filed: Feb. 19, 2026

(30) Foreign Application Priority Data
Mar. 26, 2025 (JP) 2025-051624

(51) Int. Cl. G05B 19/27

(52) U.S. Cl. CPC G05B 19/27; G05B 2219/36015

(57) ABSTRACT

An information processing device includes: a processor configured to execute a process including dividing, into a plurality of sub-areas, a work area where work is planned to be performed by at least one work machine. The processor is further configured to: acquire position information of a point group that defines an outer shape of the work area; calculate a target area for each of the sub-areas based on an overall area of the work area; and determine a range of each of the sub-areas in the work area based on the position information of the point group and the target area.

### CROSS-REFERENCE TO RELATED APPLICATIONS

This application is based on and claims priority under 35 USC 119 from Japanese Patent Application No. 2025-051624 filed on Mar. 26, 2025, the contents of which are incorporated herein by reference.

### TECHNICAL FIELD

The present disclosure relates to an information processing device, an information processing system, an area division method, and a storage medium that divide, into a plurality of sub-areas, a work area where work is planned to be performed by at least one work machine.

### BACKGROUND

Japanese Patent Publication No. 7116799B (hereinafter, referred to as Patent Literature 1) describes a work zone boundary demarcation device of an autonomously navigating work machine to demarcate boundaries that divide, into a plurality of zones, a work area where work is planned to be performed by the autonomously navigating work machine.

The work zone boundary demarcation device in Patent Literature 1 repeatedly executes simulations of work to determine the boundaries of the plurality of zones so as to improve the efficiency of the work performed by the work machine.

The work zone boundary demarcation device in Patent Literature 1 defines a work area by a map that is formed by arraying a plurality of cells in a plane of a biaxial orthogonal coordinate system of uniformly spaced horizontal and perpendicular lines, and there is a problem that a calculation load is high.

The present disclosure provides an information processing device, an information processing system, an area division method, and a program that is capable of dividing a work area into a plurality of sub-areas with a light calculation load.

### SUUMARY

A first aspect of the present disclosure relates to an information processing device including: a processor configured to execute a process including dividing, into a plurality of sub-areas, a work area where work is planned to be performed by at least one work machine. The processor is further configured to: acquire position information of a point group that defines an outer shape of the work area; calculate a target area for each of the sub-areas based on an overall area of the work area; and determine a range of each of the sub-areas in the work area based on the position information of the point group and the target area.

A second aspect of the present disclosure relates to an information processing device including: a processor configured to execute a process including dividing, into a plurality of sub-areas, a work area where work is planned to be performed by at least one work machine. The processor is further configured to: acquire area information related to the work area; calculate a target area for each of the sub-areas based on an overall area of the work area; and determine a range of each of the sub-areas in the work area based on the area information and the target area, and when determining the range of each of the sub-areas, the processor calculates an area defined by a part of an outer shape of the work area and a virtual straight line, and repeatedly moves the virtual straight line by a working width or an integer multiple of the working width in a direction perpendicular to the virtual straight line until the calculated area reaches the target area, and the processor sets the virtual straight line as a boundary of the sub-areas based on a comparison of the calculated area with the target area of the sub-area.

A third aspect of the present disclosure relates to an information processing system including: at least one work machine; and an information processing device configured to communicate with the work machine. The information processing system is configured to: execute a process including dividing, into a plurality of sub-areas, a work area where work is planned to be performed by the work machine; acquire position information of a point group that defines an outer shape of the work area; calculate a target area for each of the sub-areas based on an overall area of the work area; and determine a range of each of the sub-areas in the work area based on the position information of the point group and the target area.

A fourth aspect of the present disclosure relates to an area division method for executing by a processor a process including dividing, into a plurality of sub-areas, a work area where work is planned to be performed by at least one work machine. The area division method comprises; acquiring position information of a point group that defines an outer shape of the work area; calculating a target area for each of the sub-areas based on an overall area of the work area; and determining a range of each of the sub-areas in the work area based on the position information of the point group and the target area.

A fifth aspect of the present disclosure relates to a non-transitory computer-readable storage medium storing a program for causing a computer to execute a process including dividing, into a plurality of sub-areas, a work area where work is planned to be performed by at least one work machine. The process comprises: acquiring position information of a point group that defines an outer shape of the work area; calculating a target area for each of the sub-areas based on an overall area of the work area; and determining a range of each of the sub-areas in the work area based on the position information of the point group and the target area.

According to the present disclosure, a work area can be divided into a plurality of sub-areas with a light calculation load.

### BRIEF DESCRIPTION OF DRAWINGS

Exemplary embodiment(s) of the present disclosure will be described in detail based on the following figures, wherein

FIG. 1 is a schematic configuration diagram of an information processing system including a work machine, a terminal device, and a server;

FIG. 2 is a schematic configuration diagram of the work machine;

FIG. 3 is a schematic configuration diagram related to a control system of the work machine;

FIG. 4 is a schematic configuration diagram of the server;

FIG. 5 is a diagram illustrating acquisition of a point group that defines an outer shape of a work area;

FIG. 6 is a flowchart of an area division method;

FIG. 7 is a diagram illustrating a process (i) in a division map creation step;

FIG. 8 is a diagram illustrating processes (ii) and (iii) in the division map creation step;

FIG. 9 is a diagram (part 1) illustrating a process (iv) in the division map creation step;

FIG. 10 is a diagram (part 2) illustrating the process (iv) in the division map creation step;

FIG. 11 is a diagram (part 3) illustrating the process (iv) in the division map creation step.

FIG. 12 is a diagram (part 4) illustrating the process (iv) in the division map creation step;

FIG. 13 is a diagram (part 5) illustrating the process (iv) in the division map creation step;

FIG. 14 is a diagram illustrating a route plan in the work area;

FIG. 15 is a diagram showing a work area in which some sub-areas are separated by presence of a specific area;

FIG. 16 is a diagram illustrating a second modification in which a work area is divided based on a time during which a work machine performs work; and

FIG. 17 is a schematic configuration diagram of a third modification in which a work machine performs various processes of an area division method.

### DESCRIPTION OF EMBODIMENTS

Hereinafter, an embodiment of an information processing device, an information processing system, an area division method, and a program of the present disclosure will be described with reference to the accompanying drawings.

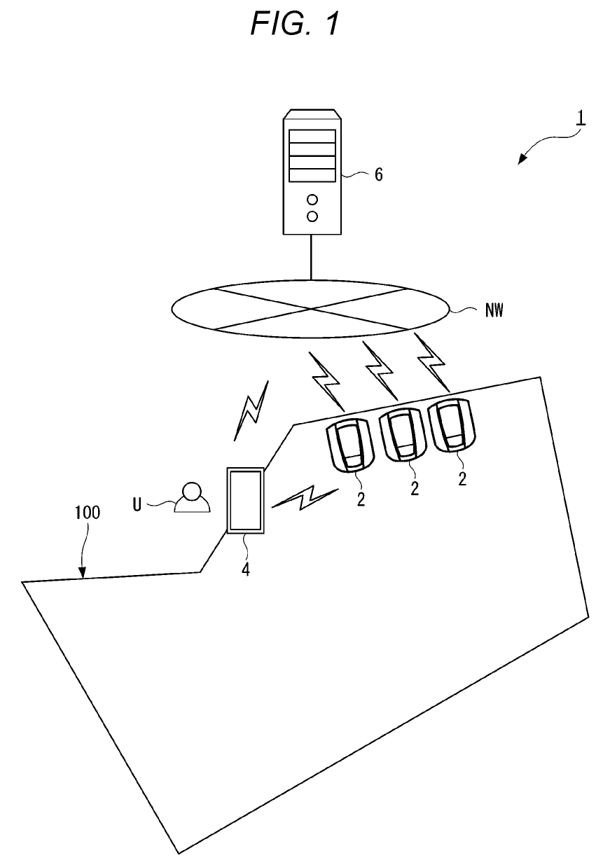

As shown in FIG. 1, an information processing system 1 according to an embodiment of the present disclosure includes at least one (three here) work machine 2 capable of autonomously traveling, a terminal device 4 capable of communicating with the work machine 2, and a server 6 capable of communicating with the work machine 2 and the terminal device 4.

In the present embodiment, the server 6 is an example of the information processing device of the present disclosure.

The work machine 2 and the terminal device 4 are used, for example, by a user U, and the server 6 is owned, for example, by a specific business operator (not shown).

The business operator provides a user application (also referred to as a user app) service related to an operation and management of the work machine 2.

The user U downloads the user app for the terminal device 4, and operates and manages the work machine 2 via the user app.

The work machine 2 is, for example, a lawn mower that mows lawns while autonomously traveling within a work area 100. However, the work machine 2 is not limited to a lawn mower and may be a snow blower, a cultivator, a rice transplanter, or the like that performs various tasks. The work machine 2 may also be rideable.

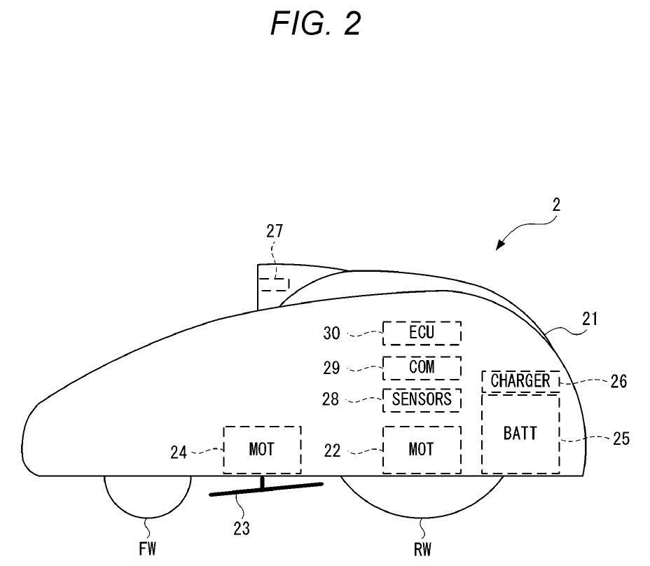

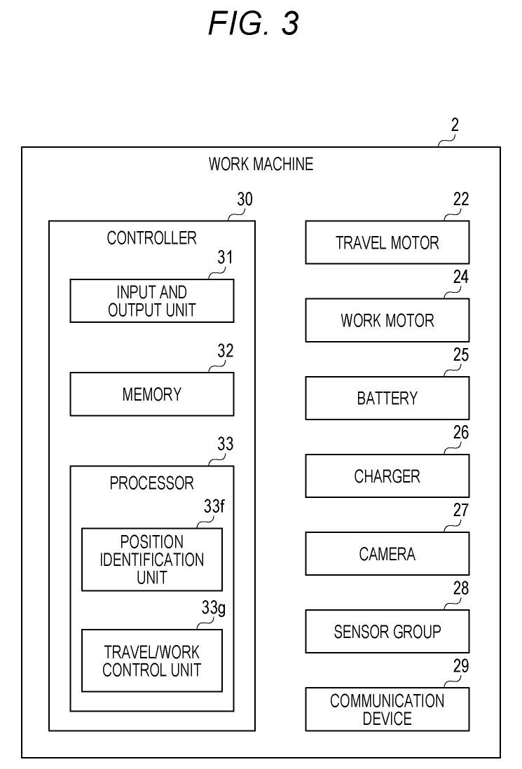

As shown in FIGS. 2 and 3, the work machine 2 includes, for example, a body 21 including a chassis and a frame, a pair of left and right front wheels FW and a pair of left and right rear wheels RW attached to the body 21, a travel motor 22 that is rotatable in forward and reverse directions and drives the rear wheels RW, a lawn mowing blade 23 provided in a central position of the body 21, a blade motor 24 that drives the blade 23, a battery 25 that supplies electric power to the travel motor 22 and the blade motor 24, a charger 26 connected to the battery 25 and charges the battery 25 with electric power supplied from an external charging station via a charging terminal, and a camera 27 that captures an image of the outside world, including at least an area ahead, of the work machine 2.

The work machine 2 includes a sensor group 28, a communication device 29 that communicates with the terminal device 4 and the server 6 via wireless communication, and a controller 30 that controls an operation of the work machine 2.

The sensor group 28 includes, for example, a direction sensor, a global navigation satellite system (GNSS) sensor, a wheel speed sensor, an angular velocity sensor, an acceleration sensor, a current sensor, a blade height sensor, and a magnetic sensor. The direction sensor detects a direction according to terrestrial magnetism. The GNSS sensor includes an antenna that receives a radio wave (GNSS signal) transmitted from a base station or a positioning satellite, and detects position information including the latitude and longitude of the work machine 2.

The communication device 29 is a communication interface that communicates with the outside of the work machine 2 under the control of the controller 30. The communication device 29 communicates wirelessly with the server 6 via a network NW, for example, using a mobile communication network such as 4G or 5G. The communication device 29 also communicates wirelessly with the terminal device 4 and another work machine 2 using short-range wireless communication such as Bluetooth (registered trademark) or Wi-Fi (registered trademark).

The controller 30 is, for example, an electronic control unit (ECU) including a microcomputer configured on a circuit board. The controller 30 includes, for example, an input and output unit 31, a memory 32, and a processor 33.

The memory 32 functions as a storage unit and includes a read only memory (ROM), a random access memory (RAM), and the like. The memory 32 stores area information of the work area 100 and a program or the like for controlling autonomous traveling and work (here, lawn mowing) of the work machine 2. The area information includes map information of the work area 100, position information of a point group N to be described later, and the like.

The processor 33 functions as a position identification unit 33f and a travel/work control unit 33g by reading and executing the program stored in the memory 32. The position identification unit 33f identifies its own position within the work area 100 based on the GNSS signals received by the GNSS sensor. The travel/work control unit 33g controls the autonomous travel and work of the work machine 2 in accordance with the program stored in the memory 32.

The terminal device 4 is, for example, a smartphone, a tablet terminal, or a personal computer (PC), and the above-described user app is installed therein. The terminal device 4 is configured to operate the work machine 2 using the user app. Although not shown in the drawings, the terminal device 4 includes a display unit such as a touch panel, a communication device that communicates with the work machine 2 and the server 6 wirelessly or via a cable, a memory in which the user app is stored, and a processor that executes predetermined processing in accordance with the program.

The server 6 is a computer that is capable of communicating with the work machine 2 and the terminal device 4 wirelessly via the network NW. The server 6 is installed, for example, in a data center or the like.

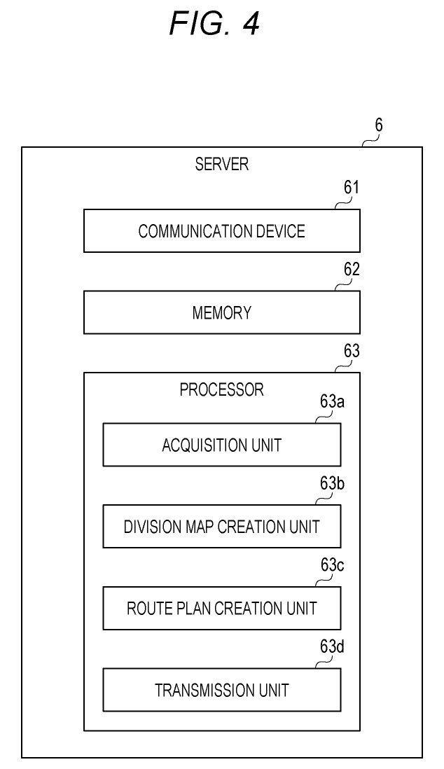

As shown in FIG. 4, the server 6 includes, for example, a communication device 61, a memory 62, and a processor 63.

The communication device 61 is a communication interface that communicates with the outside of the server 6 under the control of the processor 63. The communication device 61 communicates with the work machine 2 and the terminal device 4 wirelessly via the network NW.

The memory 62 functions as a storage unit and includes a ROM, a RAM, and the like. The memory 62 stores a program, data, and the like related to the control of the server 6. The memory 62 stores, for example, a program for executing the area division method to be described later, specifications of the work machine 2 (such as a size and a mowing width of the work machine 2), and the area information related to the work area 100.

The processor 63 is implemented by, for example, a central processing unit (CPU), and functions as an information processing device that controls the server 6. By reading and executing the program stored in the memory 62, the processor 63 functions as an acquisition unit 63a that acquires the specifications, the area information, and the like of the work machine 2, a division map creation unit 63b that creates a division map that divides the work area 100 into a plurality of sub-areas, a route plan creation unit 63c that creates a route plan for the work machine 2 based on the division map, and a transmission unit 63d that transmits the created division map and the created route plan to the work machine 2.

Next, an area division method of the work area 100 will be described. Here, an example in which the processor 63 of the server 6 executes processes of the area division method will be described.

First, a process on a user U side (on a work machine 2 side and a terminal device 4 side) that occurs before a process performed by the processor 63 of the server 6 is described. The user U uses the user app installed on the terminal device 4 to define an outer shape, which is an outer periphery shape when viewed from above, of the work area 100.

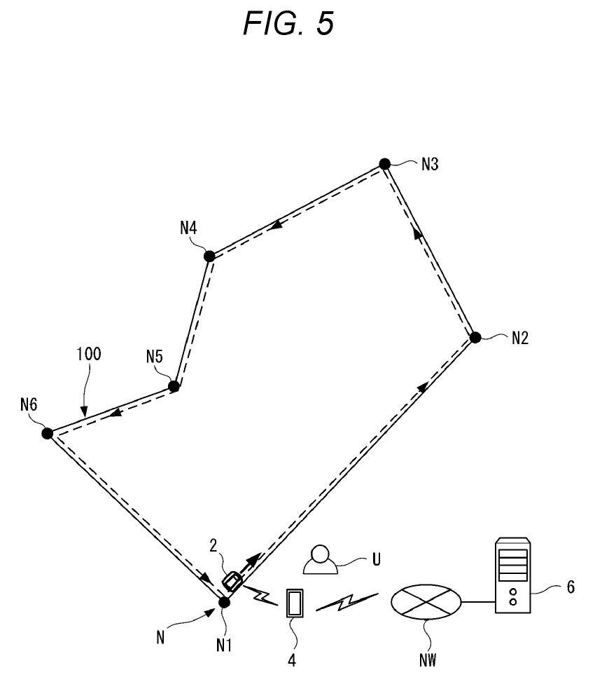

As described specifically with reference to FIG. 5, the user U manually operates the work machine 2 by using the terminal device 4 or a remote control device (not shown), and actually causes the work machine 2 to travel along the outer shape of the work area 100. If there are a plurality of work machines 2, the user U only needs to drive one of these work machines 2. The terminal device 4 acquires, as the point group N, a plurality of pieces of position information at several locations that the work machine 2 has passed through. By connecting the point group N, the outer shape of the work area 100 is defined.

As described in an example, during the traveling of the work machine 2, the user U uses the terminal device 4 to request the acquisition of the point group N at any time. The terminal device 4 stores the position information (including the latitude and longitude) of the work machine 2 at a time point of the request of the user U as a point element included in the point group N. For example, in FIG. 5, the user U requests the acquisition of the point group N when the work machine 2 passes a location where the work machine 2 changes a traveling direction, and the terminal device 4 acquires and stores, as the point group N, point elements N1 to N6 including the position information of the locations requested by the user U. The position information of the point group N may also be stored in the work machine 2.

As described in another example, during the traveling of the work machine 2, the work machine 2 transmits the position information to the terminal device 4 at a predetermined interval, and the terminal device 4 acquires and stores the position information as the point group N. The predetermined interval may be a time interval (for example, transmission is performed every few seconds) or a distance interval (for example, transmission is performed every few meters). The position information of the point group N may also be stored in the work machine 2.

In the above two examples, the point group N is acquired by actually causing the work machine 2 to travel, but the present disclosure is not limited thereto. For example, the terminal device 4 may display, on a display unit, the map information of the work area 100 on the user app, and acquire and store a plurality of locations selected by a touch operation or the like of the user U as the point group N. In this case, the position information of the point group N may also be transmitted to the work machine 2 and stored.

In addition to the acquisition of the point group N, on the user app, the user U sets a lawn direction (traveling direction of the work machine 2) during work. For example, the user U sets the lawn direction to a direction parallel to a line connecting the point element N1 and the point element N2. Here, the lawn direction does not have to be set by the user U, and may be set by the processor 33 of the work machine 2 or the processor 63 of the server 6. For example, if the user U has defined a plurality of lawn directions in advance, the processor 33 or the processor 63 may set the lawn direction by freely selecting one of the plurality of lawn directions or selecting according to a specific situation.

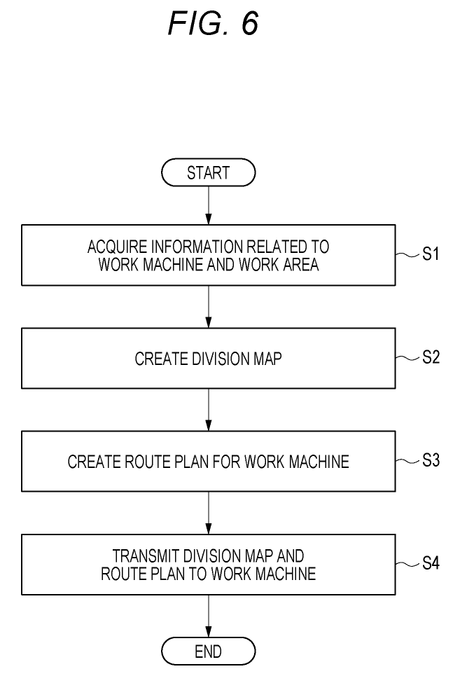

Next, the process performed by the processor 63 of the server 6 will be described. As shown in FIG. 6, the area division method includes an acquisition step S1 of acquiring information related to the work machine 2 and the work area 100, a division map creation step S2 of creating the division map of the work area 100, a route plan creation step S3 of creating the route plan for the work machines 2 based on the division map, and a transmission step S4 of transmitting the division map and the route plan to the work machines 2.

In the acquisition step S1, the processor 63 communicates with the terminal device 4 to acquire the specifications and the number of work machines 2 as the information related to the work machine 2. The specifications of the work machine 2 include, for example, a working width (a mowing width and a horizontal width of the work machine 2).

In the acquisition step S1, the processor 63 communicates with the terminal device 4 to acquire the position information of the point group N as the information related to the work area 100. Specifically, the processor 63 acquires the position information including the latitude and longitude of the point elements N1 to N6. The processor 63 also communicates with the terminal device 4 to acquire the traveling direction of the work machine 2 during work as the information related to the work area 100. Note that in the acquisition step S1, the processor 63 may also directly communicate with the work machine 2 to acquire various kinds of information.

In the division map creation step S2, the processor 63 performs processes of (i) rotating a coordinate system for calculation based on the traveling direction of the work machine 2, (ii) calculating or acquiring an overall area A0 of the work area 100, (iii) calculating target areas A1, A2, and A3 of respective sub-areas 101, 102, and 103 based on the overall area A0, and (iv) determining ranges of the sub-areas 101, 102, and 103 in the work area 100 based on the position information of the point group N and the target areas A1, A2, and A3. Each of the processes (i) to (iv) will be described in detail below.

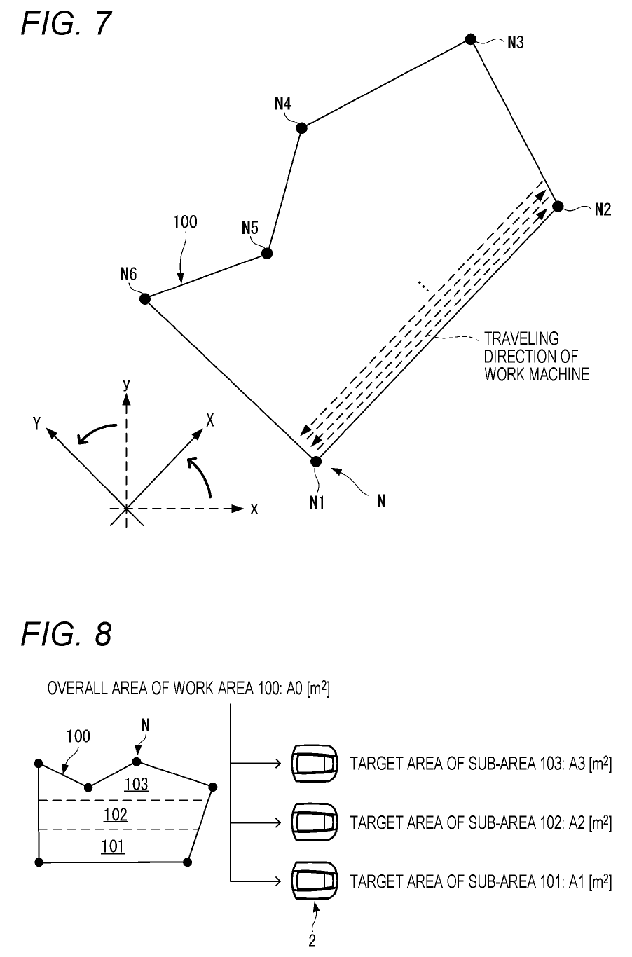

Regarding the process (i), as shown in FIG. 7, for ease of calculation, the processor 63 converts an xy coordinate system on the map into an XY coordinate system for calculation. Both the xy coordinate system and the XY coordinate system are two-axis orthogonal coordinate systems. The XY coordinate system is a coordinate system obtained by rotating the xy coordinate system such that an x direction of the xy coordinate system is parallel to the traveling direction (dashed arrow) of the work machine 2. In the present embodiment, the xy coordinate system is rotated such that an X direction of the XY coordinate system is parallel to the line connecting point element N1 and point element N2. Accordingly, the position information of the point group N is converted into coordinate information of the XY coordinate system. Note that the processor 63 may not perform the process (i).

Regarding the process (ii), as shown in FIG. 8, the processor 63 calculates the overall area A0 of the work area 100, for example, by calculating a cross product of the coordinate information (position information) of the point group N. Note that if the overall area A0 of the work area 100 can be obtained by referring to the map information of the work area 100 or if the overall area A0 can be obtained by the terminal device 4 or the work machine 2, the processor 63 may obtain the overall area A0 of the work area 100 without performing the cross product calculation based on the position information of the point group N.

Regarding the process (iii), as shown in FIG. 8, when work in the work area 100 is to be performed by a plurality of identical work machines 2 (three here), the processor 63 divides the overall area A0 by a planned number of divisions (three) of the work area 100 to calculate the target areas A1, A2, and A3 of the sub-areas 101, 102, and 103.

The target areas A1, A2, and A3 do not necessarily have to be equal, and the processor 63 may calculate the target areas A1, A2, and A3 of the sub-areas 101, 102, and 103 based on the overall area A0 and the planned number of divisions of the work area 100, and the specifications of the work machine 2. For example, since the work machines 2 with different working widths have different working speeds (for example, work area per unit time), the target area of the sub-area in which the work machine 2 with a larger working width works may be calculated to be larger than the target area of the sub-area in which the work machine 2 with a smaller working width works.

Regarding the process (iv), the processor 63 sequentially determines the range of each of the sub-areas 101, 102, and 103 based on the position information of the point group N and the target areas A1, A2, and A3. Here, a boundary between adjacent sub-areas may be included as a part of the "range" of the sub-area.

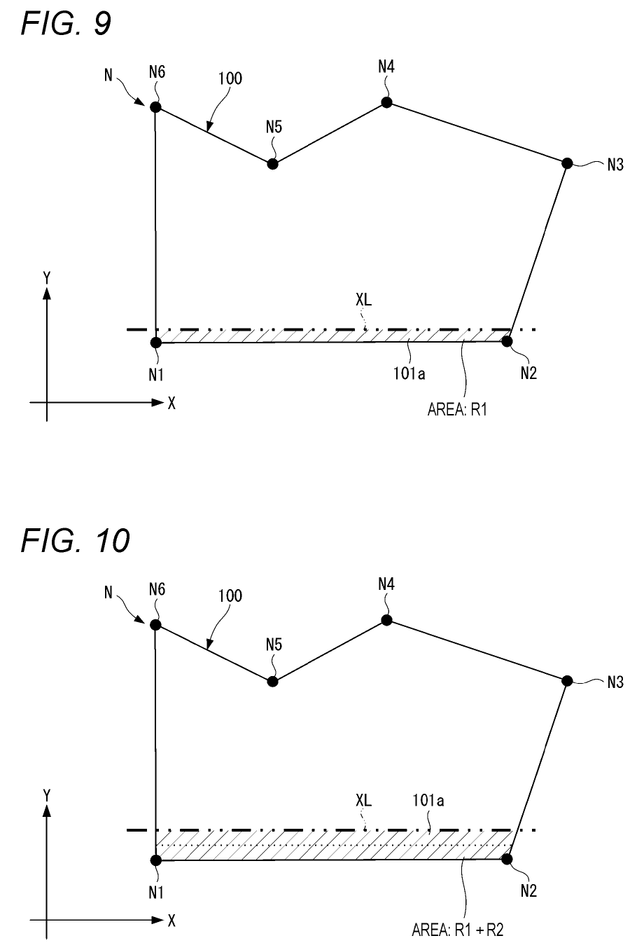

When the range of the sub-area 101 is determined, as shown in FIG. 9, the processor 63 draws a virtual straight line XL (two-dot chain line) in the work area 100. This virtual straight line XL is a line parallel to the pre-set (selected) lawn direction, and in this case, is a line parallel to the line connecting the point element N1 and the point element N2. The work machine 2 travels along the set (selected) lawn direction, and thus the virtual straight line XL can also be said to be a line parallel to the traveling direction of the work machine 2. The virtual straight line XL is positioned a distance equal to the working width in a direction perpendicular to the virtual straight line XL (that is, a Y direction). The working width is, for example, a mowing width. The user U can set the mowing width to any width.

The processor 63 calculates an area of a small area 101a (shaded portion) defined by a part of the outer shape of the work area 100 and the virtual straight line XL. The area of the small area 101a is calculated, for example, by calculating the cross product of the coordinate information of the point element N1, the point element N2, and two intersections of the outer shape of the work area 100 and the virtual straight line XL. The coordinate information of the two intersections of the outer shape of the work area 100 and the virtual straight line XL is calculated, for example, by interpolation. Here, the area of the small area 101a is assumed to be R1. The processor 63 compares the area R1 of the small area 101a with the target area A1 of the sub-area 101.

If the area R1 is smaller than the target area A1, as shown in FIG. 10, the processor 63 moves the virtual straight line XL in parallel in the Y direction by the working width. The processor 63 calculates the area of the small area 101a (shaded portion) formed after moving the virtual straight line XL. Specifically, the processor 63 calculates the area of the small area 101a by adding an area R2, which is an area increased by the movement of the virtual straight line XL, to the area R1 before moving the virtual straight line XL. The processor 63 compares an area R1 + R2 of the small area 101a with the target area A1 of the sub-area 101.

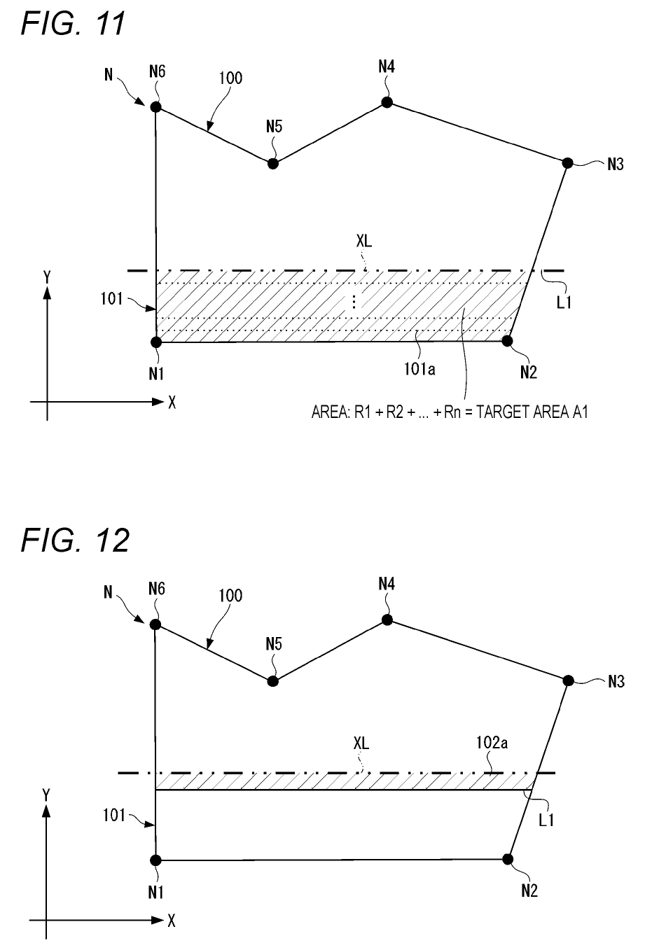

As shown in FIG. 11, the processor 63 performs the same process until the area of the small area 101a reaches the target area A1. That is, the processor 63 repeatedly moves the virtual straight line XL in parallel in the Y direction until the area of the small area 101a reaches the target area A1 to search for the boundary of the sub-area 101. A movement width of the virtual straight line XL per movement is, for example, the working width of the work machine 2. Here, "reaching" not only means that the area of the small area 101a matches the target area A1, but also can include the area of the small area 101a coming closest to the target area A1 or being within a predetermined allowable range of the target area A1.

When the processor 63 calculates the area of the small area 101a n times (n represents a natural number), in other words, when the processor 63 moves the virtual straight line XL n-1 times in parallel in the Y direction, an area R1 + R2 + ... + Rn of the small area 101a reaches the target area A1. The processor 63 sets the virtual straight line XL in this case as a division line L1 that divides the sub-area 101 from the work area 100, and determines the area defined by a part of the outer shape of the work area 100 and the division line L1 as the range of the sub-area 101.

After determining the range of the sub-area 101, the processor 63 determines the range of the sub-area 102, as shown in FIG. 12. When determining the range of the sub-area 102, the processor 63 performs the same processes as for the sub-area 101. Specifically, the processor 63 draws a virtual straight line XL in the work area 100 at a position separated from the division line L1 by the working width in the Y direction. The processor 63 calculates an area of a small area 102a (shaded portion) defined by a part of the outer shape of the work area 100 and the virtual straight line XL (including the division line L1).

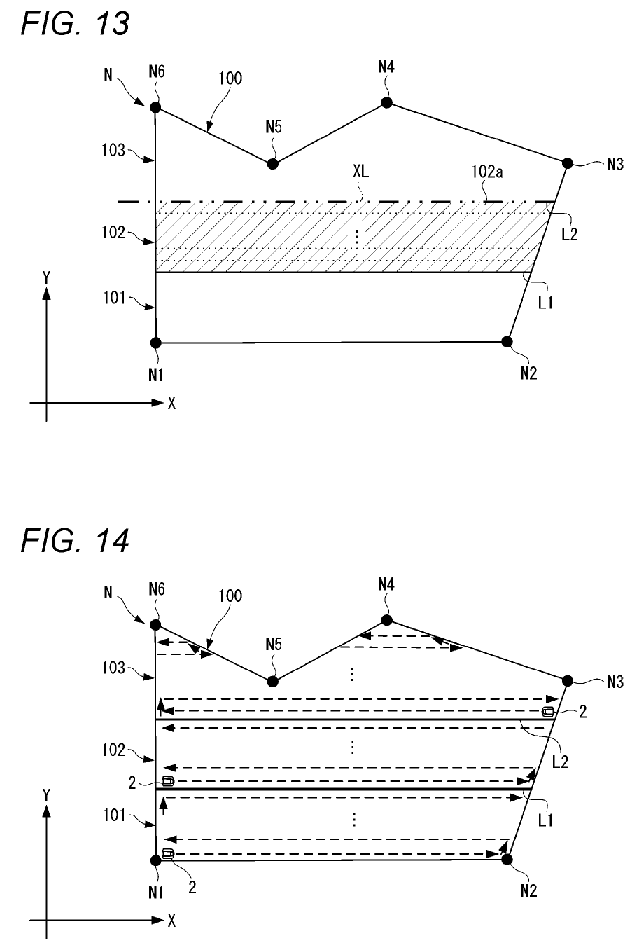

If the area of the small area 102a is smaller than the target area A2 of the sub-area 102, as shown in FIG. 13, the processor 63 repeatedly moves the virtual straight line XL in parallel in the Y direction by the working width to search for a boundary of the sub-area 102 until the area of the small area 102a reaches the target area A2. The processor 63 sets the virtual straight line XL in a case where the area of the small area 102a reaches the target area A2, as a division line L2 which divides the sub-area 102 from the work area 100. The processor 63 determines an area defined by a part of the outer shape of the work area 100, the division line L1, and the division line L2 as the range of the sub-area 102.

After determining the range of the sub-area 102, the processor 63 determines the remaining area in the work area 100 as the range of the sub-area 103. The range of the sub-area 103 is an area defined by a part of the outer shape of the work area 100 and the division line L2.

Accordingly, in the division map creation step S2, the processor 63 creates the division map of the work area 100 divided into the sub-areas 101, 102, and 103 by the division line L1 and the division line L2.

In the route plan creation step S3, the processor 63 creates a route plan for the work machine 2 to travel through each of the sub-areas 101, 102, and 103 based on the division map and the lawn direction.

In an example of the route plan shown in FIG. 14, the processor 63 assigns one work machine 2 to each of the sub-areas 101, 102, and 103. As indicated by dashed arrows, the work machine 2 travels parallel to the X direction through each of the sub-areas 101, 102, and 103, and when the work machine 2 reaches the outer shape of the work area 100, the work machine 2 travels in the Y direction by a distance of the working width, turns around, and then travels parallel to the X direction again. The work machine 2 repeats this turning movement. In such a route plan, the work machine 2 travels in a direction from one end to the other end in the Y direction (from bottom to top in the example of FIG. 14) in each of the sub-areas 101, 102, and 103. At the top of the sub-area 103, there are portions where the area is separated in the X direction (a portion including the point element N4 and a portion including the point element N6), but the work machine 2 stores the coordinate information of the outer shape of the area and can travel along the outer shape of the sub-area 103, and thus the work machine 2 can travel between both portions.

In the transmission step S4, the processor 63 controls the communication device 61 to transmit the division map and the route plan to each of the work machines 2. It is also preferable that the processor 63 transmits the map information of the entire work area 100, in addition to the division map, to each of the work machines 2. Each of the work machines 2 stores the map information and the division map in the memory 32, and travels and works based on the division map, the route plan, and the map information.

As described above, the area division method of the present embodiment performs the processes based on the point group N on the outer shape of the work area 100, and can create a division map with a lighter calculation load than, for example, that in a method of dividing the entire work area 100 into grids to create a division map based on the position information of the grids. Since an amount of data of the created division map is small, the amount of data also reduces a load on data communication between the server 6 and the work machine 2 and on data processing within the work machine 2.

The processor 63 moves the virtual straight line XL to search for the boundaries of the sub-areas (division lines L1, L2), thereby dividing the work area 100 such that adjacent sub-areas do not overlap.

In the case of the work machine 2, which is a lawn mower, the boundaries of the sub-areas are parallel to the lawn direction (the traveling direction of the work machine 2), and thus the lawn at the boundaries of the sub-areas can be aligned.

When moving the virtual straight line XL in the division map creation step S2, the processor 63 sets the movement width of the virtual straight line XL to the working width in a direction (Y direction) perpendicular to the virtual straight line XL, and thus the number of calculation times of the area of the small area resulting from the parallel movement of the virtual straight line XL is reduced. Therefore, the calculation load on the server 6 can be reduced.

In order to further reduce the calculation load, the processor 63 may set the movement width of the virtual straight line XL to an integer multiple (for example, twice) of the working width. Furthermore, if the working widths of the plurality of work machines 2 are different, the processor 63 may set the movement width of the virtual straight line XL to a least common multiple of the working widths of the work machines 2. For example, if the working widths of two work machines 2 are 20 cm and the working width of one work machine 2 is 30 cm, the processor 63 may set the movement width of the virtual straight line XL to 60 cm.

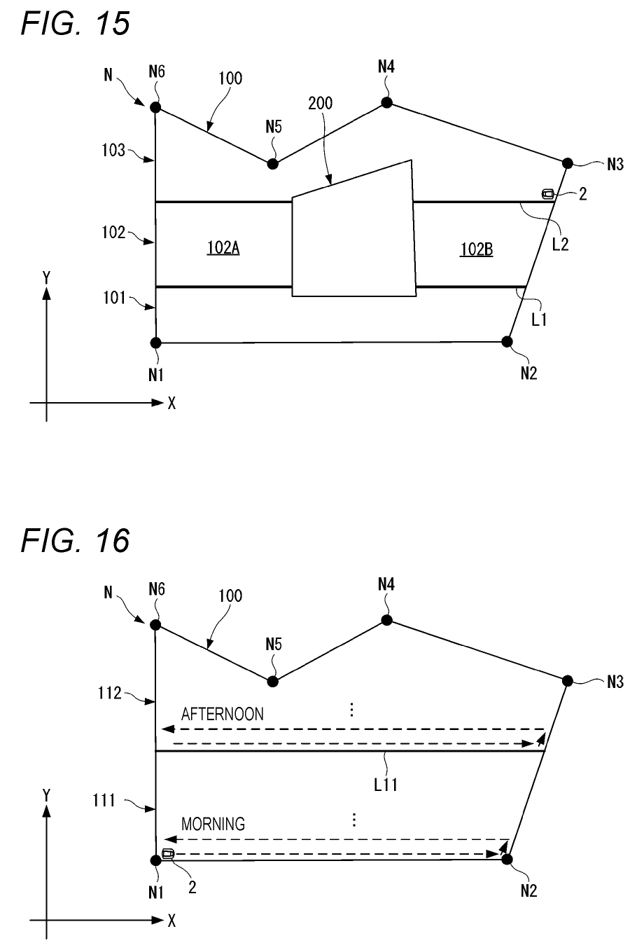

The work area 100 shown in FIG. 15 includes a specific area 200 where entering of the work machine 2 is prohibited or impossible. Even when such a work area 100 is present, the processor 63 of the server 6 can create the division map by executing various processes of the area division method described above.

In FIG. 15, the sub-area 102 is divided into a left area 102A and a right area 102B due to the presence of the specific area 200. The work machine 2 assigned to the sub-area 102 must pass through the sub-area 101 or the sub-area 103 when traveling between the left area 102A and the right area 102B. The work machine 2 receives the map information for the entire work area 100 from the server 6 and stores the entire map information in the memory 32. Therefore, the work machine 2 can travel between the left area 102A and the right area 102B through the sub-area 101 or the sub-area 103 based on the entire map information.

The area division method described above can be implemented by causing a computer, specifically, the processor 63, to execute a program prepared in advance. The program is stored in a computer-readable storage medium and executed by being read from the storage medium. In addition, the program may be provided in a form stored in a non-transitory storage medium such as a flash memory, or may be provided via a network.

### First Modification

As described above, the processor 63 can reduce the calculation load by setting the movement width of the virtual straight line XL to the working width or an integer multiple of the working width of the work machine 2. Therefore, even if, in the division map creation step S2, the processor 63 does not use the position information of the point group N but instead uses, as the area information, the position information of the grids when the entire work area 100 is divided into the grids, the processor 63 can reduce the calculation load.

### Second Modification

In the embodiment described above, the processor 63 of the server 6 determines the planned number of divisions based on the number of work machines 2 and divides the work area 100 into a plurality of sub-areas, but the present disclosure is not limited thereto, and for example, the planned number of divisions may be determined based on a time during which the work machines 2 perform work, and the work area 100 may be divided into the plurality of sub-areas.

Specifically, as shown in FIG. 16, if the user U wants to have one work machine 2 work in the morning and in the afternoon, the processor 63 may divide the work area 100 into two sub-areas 111 and 112 by a division line L11, and create a plan in which the work machine 2 works in the sub-area 111 in the morning and works in the sub-area 112 in the afternoon.

### Third Modification

In the embodiment described above, the server 6 executes the various processes of the area division method, but the present disclosure is not limited thereto. For example, the processor 33 of the work machine 2 may execute the various processes of the area division method. In other words, the work machine 2 may be the information processing device of the present disclosure.

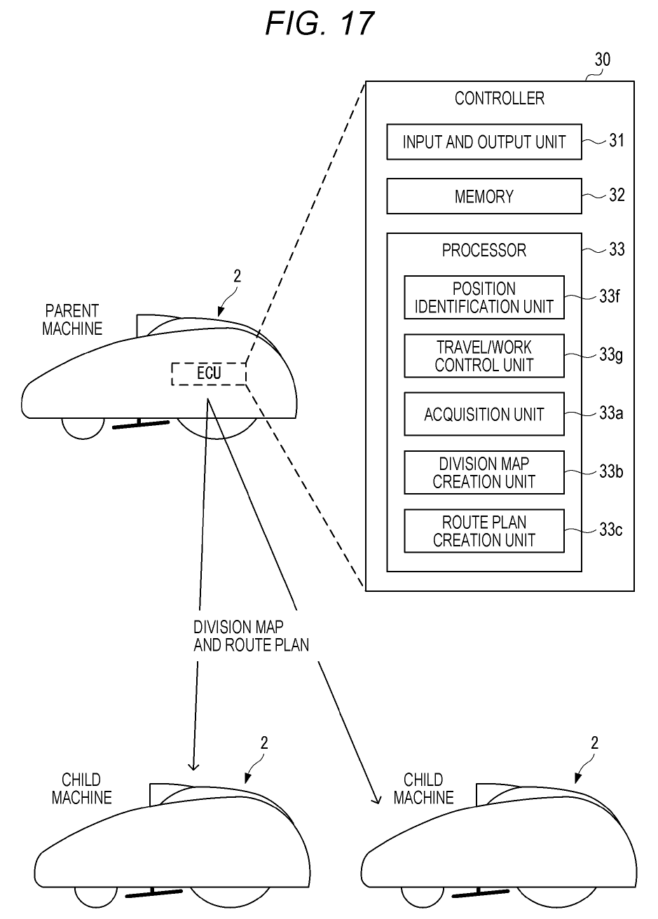

As shown in FIG. 17, the processor 33 of the work machine 2 further includes, as functional units, an acquisition unit 33a, a division map creation unit 33b, and a route plan creation unit 33c. The acquisition unit 33a, the division map creation unit 33b, and the route plan creation unit 33c have the same configurations as those of the acquisition unit 63a, the division map creation unit 63b, and the route plan creation unit 63c of the server 6 described above, and respectively execute the processes of the acquisition step S1, the division map creation step S2, and the route plan creation step S3 described above.

In the example shown in FIG. 17, the work machine 2 that actually travels along the outer shape of the work area 100 and acquires the position information of the point group N due to the operation of the user U is referred to as a parent machine, and another work machine 2 is referred to as a child machine. The processor 33 of the work machine 2, as the parent machine, executes the processes of the division map creation step S2 and the route plan creation step S3, and transmits the created division map and the route plan to the work machine 2, as the child machine.

The processor of the terminal device 4 may be configured to execute various processes of the area division method. That is, the terminal device 4 may be the information processing device of the present disclosure.

Two or three of the server 6, the work machine 2, and the terminal device 4 may cooperate to execute the various processes of the area division method, that is, the information processing system 1 as a whole may execute the various processes of the area division method. For example, the processor 33 of the work machine 2 may acquire the position information of the point group N, calculate the overall area A0 of the work area 100 and the target areas A1, A2, and A3 of the respective sub-areas 101, 102, and 103 based on the position information of the point group N, transmit the position information and the area information of the point group N to the server 6, and the processor 63 of the server 6 may determine the range of each of the sub-areas 101, 102, and 103 based on the received information. For another example, the processor 63 of the server 6 may execute the acquisition step S1 and the division map creation step S2, and the processor 33 of the work machine 2 may execute the route plan creation step S3 based on the division map received from the server 6.

Although an embodiment and various modifications of the present disclosure have been described above with reference to the accompanying drawings, it is needless to say that the present disclosure is not limited to the embodiment. It is apparent to those skilled in the art that various changes or modifications can be conceived within the scope described in the claims, and it is understood that the changes or modifications naturally fall within the technical scope of the present disclosure. In addition, the respective constituent elements in the above embodiment may be combined as desired without departing from the gist of the disclosure.

In the present description, at least the following matters are described. In the parentheses, the corresponding constituent elements and the like in the above embodiment are shown as examples, but the present disclosure is not limited thereto.

(1) An information processing device (server 6, work machine 2, terminal device 4) including:

a processor (processor 63, 33) configured to execute a process including dividing, into a plurality of sub-areas (sub-areas 101, 102, 103), a work area (work area 100) where work is planned to be performed by at least one work machine (work machine 2), in which

the processor is further configured to

acquire position information of a point group (point group N) that defines an outer shape of the work area,

calculate a target area (target areas A1, A2, A3) for each of the sub-areas based on an overall area (overall area A0) of the work area, and

determine a range of each of the sub-areas in the work area based on the position information of the point group and the target area.

According to (1), the ranges of the sub-areas are determined using the position information of the point group that defines the outer shape of the work area, and thus the process can be executed with a small calculation load.

(2) The information processing device according to claim (1), in which

the processor calculates the target area for each of the sub-areas based on the overall area and a planned number of divisions of the work area.

According to (2), the processor can calculate the target area of each of the sub-areas through a simple calculation based on the overall area and the planned number of divisions of the work area.

(3) The information processing device according to (2), in which

the processor calculates the target area for each of the sub-areas based on the overall area and the planned number of divisions of the work area, and a specification of the work machine.

According to (3), the target area of each of the sub-areas is calculated based on the specification of the work machine, and thus the target area can be set flexibly.

(4) The information processing device according to any one of (1) to (3), in which

when determining the range of each of the sub-areas, the processor is configured to

calculate an area defined by a part of the outer shape of the work area and a virtual

straight line (virtual straight line XL), and

set the virtual straight line as a boundary of the sub-area based on a comparison of the calculated area with the target area of the sub-area.

According to (4), the work area can be divided such that adjacent sub-areas do not overlap.

(5) The information processing device according to (4), in which

the processor calculates the area defined by the part of the outer shape of the work area and the virtual straight line, compares the calculated area with the target area, and repeatedly moves the virtual straight line until the calculated area reaches the target area.

According to (5), the boundary of the sub-areas can be searched by repeatedly moving the virtual straight line.

(6) The information processing device according to (5), in which

the processor moves the virtual straight line in parallel in a direction perpendicular to the virtual straight line.

According to (6), the virtual straight line is moved in parallel in an orthogonal direction, and thus the calculation can be simplified, and the calculation load can be reduced.

(7) The information processing device according to (5) or (6), in which

the processor sets a movement width of the virtual straight line to a working width or an integer multiple of the working width in a direction perpendicular to the virtual straight line.

According to (7), the virtual straight line is moved by the working width or the integer multiple of the working width, and thus the calculation load can be reduced.

(8) The information processing device according to (7), in which

the processor determines the working width based on a specification of the work machine.

According to (8), an appropriate working width can be set.

(9) The information processing device according to (7) or (8), in which

the work area is an area where work is planned to be performed by a plurality of work machines, and

the processor sets the movement width of the virtual straight line to a least common multiple of working widths of the respective work machines.

According to (9), the virtual line is moved by the least common multiple of the working widths of the work machines, and thus the calculation load is further reduced.

(10) An information processing device including:

a processor configured to execute a process including dividing, into a plurality of sub-areas, a work area where work is planned to be performed by at least one work machine, in which

the processor is configured to

acquire area information related to the work area,

calculate a target area for each of the sub-areas based on an overall area of the work area, and

determine a range of each of the sub-areas in the work area based on the area information and the target area, and

when determining the range of each of the sub-areas, the processor is further configured to

calculate an area defined by a part of an outer shape of the work area and a virtual straight line, and repeatedly move the virtual straight line by a working width or an integer multiple of the working width in a direction perpendicular to the virtual straight line until the calculated area reaches the target area, and

set the virtual straight line as a boundary of the sub-areas based on a comparison of the calculated area with the target area of the sub-area.

According to (10), the boundary of the sub-areas can be searched by repeatedly moving the virtual straight line. In this case, the virtual straight line is moved by the working width or the integer multiple of the working width, and thus the calculation load can be reduced.

(11) The information processing device according to claim (10), in which

the processor calculates the target area for each of the sub-areas based on the overall area and a planned number of divisions of the work area.

According to (11), the processor can calculate the target area of the sub-area through a simple calculation based on the overall area and the planned number of divisions of the work area.

(12) The information processing device according to (11), in which

the processor calculates the target area for each of the sub-areas based on the overall area and the planned number of divisions of the work area, and a specification of the work machine.

According to (12), the target area of each of the sub-areas is calculated based on the

specification of the work machine, and thus the target area can be set flexibly.

(13) The information processing device according to any one of (10) to (12), in which

the processor determines the working width based on a specification of the work machine.

According to (13), an appropriate working width can be set.

(14) The information processing device according to any one of (10) to (13), in which

the work area is an area where work is planned to be performed by a plurality of work machines, and

the processor sets a movement width of the virtual straight line to a least common multiple of working widths of the respective work machines.

According to (14), the virtual line is moved by the least common multiple of the working widths of the work machines, and thus the calculation load is further reduced.

(15) An information processing system (information processing system 1) including:

at least one work machine; and

an information processing device configured to communicate with the work machine, in which

the information processing system is configured to

execute a process including dividing, into a plurality of sub-areas, a work area where work is planned to be performed by the work machine,

acquire position information of a point group that defines an outer shape of the work area,

calculate a target area for each of the sub-areas based on an overall area of the work area, and

determine a range of each of the sub-areas in the work area based on the position information of the point group and the target area.

According to (15), the ranges of the sub-areas are determined using the position information of the point group that defines the outer shape of the work area, and thus the process can be executed with a small calculation load.

(16) An information processing system including:

at least one work machine; and

an information processing device configured to communicate with the work machine, in which

the information processing system is configured to

execute a process including dividing, into a plurality of sub-areas, a work area where work is planned to be performed by at least one work machine,

acquire area information related to the work area,

calculate a target area for each of the sub-areas based on an overall area of the work area, and

determine a range of each of the sub-areas in the work area based on the area information and the target area, and

when determining the range of each of the sub-areas, the information processing system is further configured to

calculate an area defined by a part of an outer shape of the work area and a virtual straight line, and repeatedly move the virtual straight line by a working width or an integer multiple of the working width in a direction perpendicular to the virtual straight line until the calculated area reaches the target area, and

set the virtual straight line as a boundary of the sub-areas based on a comparison of the calculated area with the target area of the sub-area.

According to (16), the boundary of the sub-areas can be searched by repeatedly moving the virtual straight line. In this case, the virtual straight line is moved by the working width or the integer multiple of the working width, and thus the calculation load can be reduced.

(17) An area division method including:

executing, by a processor (processor 63, 33), a process including dividing, into a plurality of sub-areas, a work area where work is planned to be performed by at least one work machine;

acquiring position information of a point group that defines an outer shape of the work area;

calculating a target area for each of the sub-areas based on an overall area of the work area; and

determining a range of each of the sub-areas in the work area based on the position information of the point group and the target area.

According to (17), the ranges of the sub-areas are determined using the position

information of the point group that defines the outer shape of the work area, and thus the process can be executed with a small calculation load.

(18) An area division method including:

executing, by a processor, a process including dividing, into a plurality of sub-areas, a work area where work is planned to be performed by at least one work machine;

acquiring area information related to the work area;

calculating a target area for each of the sub-areas based on an overall area of the work area;

determining a range of each of the sub-areas in the work area based on the area information and the target area; and

when determining the range of each of the sub-areas,

calculating an area defined by a part of an outer shape of the work area and a virtual straight line, and repeatedly moving the virtual straight line by a working width or an integer multiple of the working width in a direction perpendicular to the virtual straight line until the calculated area reaches the target area; and

setting the virtual straight line as a boundary of the sub-areas based on a comparison of the calculated area with the target area of the sub-area.

According to (18), the boundary of the sub-areas can be searched by repeatedly moving the virtual straight line. In this case, the virtual straight line is moved by the working width or the integer multiple of the working width, and thus the calculation load can be reduced.

(19) A program that divides, into a plurality of sub-areas, a work area where work is planned to be performed by at least one work machine, in which

the program causes a computer (processor 63, 33) to execute processes of

acquiring position information of a point group that defines an outer shape of the work area,

calculating a target area for each of the sub-areas based on an overall area of the work area, and

determining a range of each of the sub-areas in the work area based on the position information of the point group and the target area.

According to (19), the ranges of the sub-areas are determined using the position information of the point group that defines the outer shape of the work area, and thus the process can be executed with a small calculation load.

(20) A program that divides, into a plurality of sub-areas, a work area where work is planned to be performed by at least one work machine, in which

the program causes a computer to execute processes of

acquiring area information related to the work area,

calculating a target area for each of the sub-areas based on an overall area of the work area,

determining a range of each of the sub-areas in the work area based on the area information and the target area, and

when causing the computer to execute the process including determining the range of each of the sub-areas, the program causes the computer to execute processes of

calculating an area defined by a part of an outer shape of the work area and a virtual straight line, and repeatedly moving the virtual straight line by a working width or an integer multiple of the working width in a direction perpendicular to the virtual straight line until the calculated area reaches the target area, and

setting the virtual straight line as a boundary of the sub-areas based on a comparison of the calculated area with the target area of the sub-area.

According to (20), the boundary of the sub-areas can be searched by repeatedly moving the virtual straight line. In this case, the virtual straight line is moved by the working width or the integer multiple of the working width, and thus the calculation load can be reduced.

1. An information processing device comprising:
a processor configured to execute a process including dividing, into a plurality of sub-areas, a work area where work is planned to be performed by at least one work machine, wherein
the processor is further configured to:
acquire position information of a point group that defines an outer shape of the work area;
calculate a target area for each of the sub-areas based on an overall area of the work area; and
determine a range of each of the sub-areas in the work area based on the position information of the point group and the target area.

2. The information processing device according to claim 1, wherein
the processor calculates the target area for each of the sub-areas based on the overall area and a planned number of divisions of the work area.

3. The information processing device according to claim 2, wherein
the processor is configured to calculate the target area for each of the sub-areas based on the overall area and the planned number of divisions of the work area, and a specification of the work machine.

4. The information processing device according to claim 1, wherein
when determining the range of each of the sub-areas,
the processor calculates an area defined by a part of the outer shape of the work area and a virtual straight line, and
the processor sets the virtual straight line as a boundary of the sub-area based on a comparison of the calculated area with the target area of the sub-area.

5. The information processing device according to claim 4, wherein
the processor is configured to calculate the area defined by the part of the outer shape of the work area and the virtual straight line, compares the calculated area with the target area, and repeatedly move the virtual straight line until the calculated area reaches the target area.

6. The information processing device according to claim 5, wherein
the processor is configured to move the virtual straight line in parallel in a direction perpendicular to the virtual straight line.

7. The information processing device according to claim 5, wherein
the processor is configured to set a movement width of the virtual straight line to a working width in a direction perpendicular to the virtual straight line or an integer multiple of the working width.

8. The information processing device according to claim 7, wherein
the processor is configured to determine the working width based on a specification of the work machine.

9. The information processing device according to claim 7, wherein
the work area is an area where work is planned to be performed by a plurality of work machines, and
the processor is configured to set the movement width of the virtual straight line to a least common multiple of working widths of the respective work machines.

10. An information processing device comprising:
a processor configured to execute a process including dividing, into a plurality of sub-areas, a work area where work is planned to be performed by at least one work machine, wherein
the processor is further configured to:
acquire area information related to the work area;
calculate a target area for each of the sub-areas based on an overall area of the work area; and
determine a range of each of the sub-areas in the work area based on the area information and the target area, and
when determining the range of each of the sub-areas,
the processor calculates an area defined by a part of an outer shape of the work area and a virtual straight line, and repeatedly moves the virtual straight line by a working width or an integer multiple of the working width in a direction perpendicular to the virtual straight line until the calculated area reaches the target area, and
the processor sets the virtual straight line as a boundary of the sub-areas based on a comparison of the calculated area with the target area of the sub-area.

11. The information processing device according to claim 10, wherein
the processor is configured to calculate the target area for each of the sub-areas based on the overall area and a planned number of divisions of the work area.

12. The information processing device according to claim 11, wherein
the processor is configured to calculate the target area for each of the sub-areas based on the overall area and the planned number of divisions of the work area, and a specification of the work machine.

13. The information processing device according to claim 10, wherein
the processor is configured to determine the working width based on a specification of the work machine.

14. The information processing device according to claim 10, wherein
the work area is an area where work is planned to be performed by a plurality of work machines, and
the processor is configured to set a movement width of the virtual straight line to a least common multiple of working widths of the respective work machines.

15. An information processing system comprising:
at least one work machine; and
an information processing device configured to communicate with the work machine, wherein
the information processing system is configured to:
execute a process including dividing, into a plurality of sub-areas, a work area where work is planned to be performed by the work machine;
acquire position information of a point group that defines an outer shape of the work area;
calculate a target area for each of the sub-areas based on an overall area of the work area; and
determine a range of each of the sub-areas in the work area based on the position information of the point group and the target area.

16. An area division method for executing by a processor a process including dividing, into a plurality of sub-areas, a work area where work is planned to be performed by at least one work machine, the area division method comprising;
acquiring position information of a point group that defines an outer shape of the work area;
calculating a target area for each of the sub-areas based on an overall area of the work area; and
determining a range of each of the sub-areas in the work area based on the position information of the point group and the target area.

17. A non-transitory computer-readable storage medium storing a program for causing a computer to execute a process including dividing, into a plurality of sub-areas, a work area where work is planned to be performed by at least one work machine, the process comprising:
acquiring position information of a point group that defines an outer shape of the work area;
calculating a target area for each of the sub-areas based on an overall area of the work area; and
determining a range of each of the sub-areas in the work area based on the position information of the point group and the target area.
